(19) United States
(12) Patent Application Publication
(10) Pub. No.: US 2019/0317049 A1
(43) Pub. Date: Oct. 17, 2019

(54) METHODS AND SYSTEMS FOR PROVIDING PROMPTED SETUP AND INSPECTION DURING NON-DESTRUCTIVE TESTING (NDT)

(71) Applicant: Illinois Tool Works Inc., Glenview, IL (US)

(72) Inventors: Sakif Bin Ferdous, Skokie, IL (US); Raymond D. Berry, III, Hoffman Estates, IL (US); David John Fry, Evanston, IL (US); David M. Geis, Chicago, IL (US); Emily Newhouse, Chicago, IL (US)

(21) Appl. No.: 16/387,133

(22) Filed: Apr. 17, 2019

Related U.S. Application Data
(60) Provisional application No. 62/659,002, filed on Apr. 17, 2018.

(51) Int. Cl. G01N 27/82; G09B 19/00

(52) U.S. Cl. CPC G01N 27/82; G09B 19/003

(57) ABSTRACT

Systems and methods are provided for prompted setup and inspection during non-destructive testing (NDT) based inspections.

### CLAIM OF PRIORITY

This patent application claims priority to and benefit from U.S. Provisional Patent Application Ser. No. 62/659,002, filed on Apr. 17, 2018. The above identified application is hereby incorporated herein by reference in its entirety.

### BACKGROUND

Non-destructive testing (NDT) is used to evaluate properties and/or characteristics of material, components, and/or systems without causing damage or altering the tested item. Because non-destructive testing does not permanently alter the article being inspected, it is a highly valuable technique, allowing for savings in cost and/or time when used for product evaluation, troubleshooting, and research. Frequently used non-destructive testing methods include magnetic-particle inspections, eddy-current testing, liquid (or dye) penetrant inspection, radiographic inspection, ultrasonic testing, and visual testing. Non-destructive testing (NDT) is commonly used in such fields as mechanical engineering, petroleum engineering, electrical engineering, systems engineering, aeronautical engineering, medicine, art, and the like.

In some instances, dedicated material and/or products may be used in non-destructive testing. For example, non-destructive testing of particular type of articles may entail applying (e.g., by spraying on, pouring into, passing through, etc.), to the would-be tested article or part, a material that is configured for performing the non-destructive testing. In this regard, such material (referred to hereinafter as “NDT material”) would have particular characteristics (e.g., magnetic, visual, etc.) suitable for the non-destructive testing—e.g., characteristics that would allow or enhance detection of defects, irregularities, and/or imperfections (referred to collectively hereinafter as “defects”) in the article during non-destructive testing (NDT) based inspections.

The non-destructive testing (NDT) based inspections may be conducted in different manner—with respect to many by which defects may be detected. For example, in some instances, the NDT based inspections are conducted visually—that is, where the detection of defects is done by visually inspecting the inspected articles. This may be particular allowed or enhance by used of NDT material. In this regard, the application of NDT material may allow or enhance visual NDT based inspections, such as by making the defects more easily detected based on the particular characteristics of NDT material. For example, the defects may be visually identified based on, e.g., color contrast or some light-related behavior.

In some instances, ambient light may be used in such visual inspections—that is, the users may simply visually inspect the article in a well-lit area, such as after application of the NDT material. Alternatively or additionally, a light source (e.g., a special lamp) may be used within the system or setup being used to conduct the NDT inspection. In this regard, such light source may provide light that meets particular criteria for conducting the inspections.

Non-destructive testing (NDT) poses some challenges and have some limitations, however, particularly when conducted in accordance with conventional approaches. For example, conducting NDT based inspections may be complicated by variations in articles being inspected, requirements of different types of inspections, and inspection conditions, and conventional approaches may fail to account for that.

Further limitations and disadvantages of conventional approaches will become apparent to one management of skill in the art, through comparison of such approaches with some aspects of the present method and system set forth in the remainder of this disclosure with reference to the drawings.

### BRIEF SUMMARY

Aspects of the present disclosure relate to product testing and inspection. More specifically, various implementations in accordance with the present disclosure are directed to methods and systems for prompted setup and inspection, substantially as illustrated by or described in connection with at least one of the figures, and as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 illustrates an example non-destructive testing (NDT) inspection setup, which may be configured for operation in accordance with the present disclosure.

FIG. 2 illustrates an example controller for use in non-destructive testing (NDT) based setups supporting prompted setup and inspection, in accordance with aspects of the present disclosure.

FIG. 3 illustrates a flowchart of an example process for conducting non-destructive testing (NDT) in an NDT inspection setup that supports prompted setup and inspection, in accordance with aspects of the present disclosure.

### DETAILED DESCRIPTION

Various implementations in accordance with the present disclosure are directed to providing enhanced and optimized non-destructive testing (NDT) inspections, particularly by implementing and operating non-destructive testing (NDT) based setups with prompted setup and inspection. In this regard, as noted above, non-destructive testing (NDT) may have various challenges and limitations. For example, conventional solutions for conducting NDT based inspections may be complicated by variations in articles being inspected, requirements of different types of NDT inspections, and inspection conditions. This may be particularly challenging when users may be not sufficiently experienced to appreciate or know how to account for such variations. Therefore, NDT setups or systems that overcome at least some of these shortcomings may be desirable.

Accordingly, implementations in accordance with the present disclosure address such issues and shortcomings, such as by providing non-destructive testing (NDT) based setups that support prompted setup and inspection, which may be configured for providing output to users to assist in performing NDT based inspections—including while preparing for the inspection, conducting the inspection, and/or assessing outcome of the inspection.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein, an “inspection component” includes any component of an apparatus, a machine, and/or a setup configured for performing or facilitating non-destructive testing (NDT) inspection of articles. For example, an “inspection component” may include any one of: a structure or frame element (e.g., of the apparatus or the machine, or the setup as a whole), a holder component configured to hold the article being inspected (and, optionally, to position it in a particular manner for conducting the inspection), a triggering component configured to trigger or otherwise cause a particular effect or characteristics in the article (e.g., magnetization component configured for magnetizing the article, in magnetization based inspection), an application component configured for applying non-destructive testing (NDT) material to the article (e.g., in penetrant based inspection), a light source configured to emit light during the inspection, and the like. In some instances, inspection components may originate or otherwise be obtained from different sources (e.g., different manufacturers), and may be combined together—e.g., when constructing an inspection setup.

An example system for non-destructive testing (NDT), in accordance with the present disclosure, may include one or more inspection components configured to apply a non-destructive testing (NDT) inspection of an article; an output component configured to provide output to an operator of the system during the non-destructive testing (NDT) inspection; and one or more circuits configured to: select based on one or both of the non-destructive testing (NDT) inspection and the article, corresponding inspection guide data; generate based on the selected inspection guide data, one or more output indications for assisting the operator during the non-destructive testing (NDT) inspection, with the one or more output indications comprising instructions and/or information relating to performing the non-destructive testing (NDT) inspection; and provide the one or more output indications to the operator via the output component.

In an example implementation, the one or more circuits may be configured for determining for each of the one or more output indications corresponding output related conditions and/or parameters; and providing each of the one or more output indications via the output component to the operator based on the corresponding output related conditions and/or parameters.

In an example implementation, the one or more circuits may be configured for determining for each of the one or more output indications corresponding output related conditions and/or parameters based on one or more of: a type of inspection, a type of article, one or more parameters associated with the article, and a stage of inspection.

In an example implementation, the one or more circuits may be configured for storing at least a preprogrammed portion of the inspection guide data.

In an example implementation, the one or more circuits may be configured for adaptively generating or modifying at least a portion of the inspection guide data.

In an example implementation, the one or more circuits may be configured for adaptively generating or modifying the at least a portion of the inspection guide data based on a learning algorithm.

In an example implementation, the learning algorithm may be configured based on pattern recognition; and the one or more circuits may be configured for generate pattern recognition based control data for generating or modifying the at least a portion of the inspection guide data.

In an example implementation, the output component may comprise a visual output device.

In an example implementation, the output component may comprise an audible output device.

In an example implementation, the system may be configured for magnetic non-destructive testing (NDT) inspection.

In an example implementation, where the system is configured for magnetic non-destructive testing (NDT) inspection, the one or more inspection components comprise: a current generator that generates an electrical current; and one or more electrical contacts configured for apply the electrical current to the article during the magnetic non-destructive testing (NDT) inspection, wherein the application of the electric current creates a magnetic field in the inspection article.

In an example implementation, the system may be configured as a magnetic wet bench, and the one or more inspection components may comprise a container configured for storing non-destructive testing (NDT) magnetic solution; and an application system configured for applying the NDT magnetic solution during inspection. The one or more circuits may be configured for: power on the magnetic wet bench at a pre-set start time; and cause agitating of the NDT magnetic solution for a pre-set agitation duration.

An example method for non-destructive testing (NDT), in accordance with the present disclosure, may include performing, in response to one or more output indications provided to an operator via an output component of a non-destructive testing (NDT) setup, one or more actions corresponding to at least of: setting up an article for non-destructive testing (NDT) inspection in the non-destructive testing (NDT) setup; setting up and/or configuring at least one component of the non-destructive testing (NDT) setup; conducting the non-destructive testing (NDT) inspection of the article; and assessing outcome of the non-destructive testing (NDT) inspection of the article. The one or more output indications may be configured for assisting the operator during the non-destructive testing (NDT) inspection of the article. The one or more output indications comprise instructions and/or information relating to performing the non-destructive testing (NDT) inspection. The one or more output indications may be generated based on a particular inspection guide data. The inspection guide data may be selected based on one or both of the non-destructive testing (NDT) inspection and the article.

In an example implementation, setting up the article may comprise at least one of: loading the article within the non-destructive testing (NDT) setup; securing the article in a particular position; and applying to the article non-destructive testing (NDT) related material configured for exhibit one or more distinctive characteristics at areas in the article corresponding to defects.

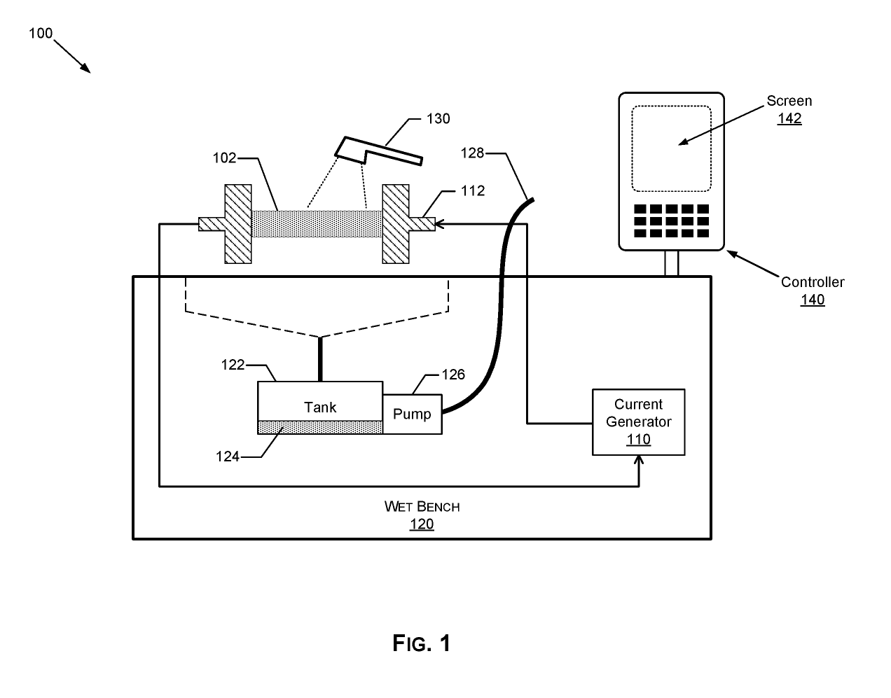

FIG. 1 illustrates an example non-destructive testing (NDT) inspection setup, which may be configured for operation in accordance with the present disclosure. Shown in FIG. 1 is an NDT setup 100 which may be used in performing NDT inspections.

The NDT setup 100 may comprise various components configured for performing non-destructive testing (NDT) inspection of articles (e.g., machine parts and the like), such as in accordance with particular NDT inspection methodology and/or technique. In this regard, the goal with any NDT inspection technique is to make defects in inspected article detectable during the inspection, and to do so without damaging or otherwise altering the inspected article. Various NDT inspections techniques may be used. Two example techniques are “magnetic particle inspection” (MPI) technique and the “liquid penetrant inspection” (LPI) technique, with the MPI technique typically being used with ferrous material, and the LPI technique typically being used with non-ferrous material (e.g., aluminum, brass, etc.).

As noted, the goal with any NDT inspection is making defects detectable. In this regard, various forms of detections may be used or supported in NDT inspections. For example, the inspection and accordingly the detection of defects may be done visually. In this regard, with visual NDT inspections, articles may be inspected, and defects therein may be detected visually—e.g., using ambient light and/or light sources (e.g., a lamp) incorporated into the NDT setups. Such light sources may be configured to emit light in particular manner. For example, light sources used in NDT setups may be designed and/or configured to emit white light, a light of other type (e.g., ultraviolet (UV) light), or any combination thereof.

In some instances, NDT setups (e.g., the NDT setup 100) may incorporate special measures for optimizing inspection environment. For example, in NDT setups configured for visual or light based inspections, an inspection enclosure may be used to ensure a suitable lighting environment, such as by blocking or otherwise limiting ambient light. This may be done to allowing controlled the lighting environment for the inspection, by ensuring that there is no light within the area where the inspection takes place, or that all or most of the light within the area where the inspection takes place originates from light sources of the NDT setups. Such inspection enclosure may be configured, for example, as a tent-like structure or any other structure that provide sufficient shading.

In some instances, NDT inspections may entail use of NDT material, which may be applied to the inspected articles, such as to facilitate or enhance detectability of the defects. In this regard, the NDT material may be selected or configured to cause or enhance identification of defects, such as based on particular exhibited behavior or characteristics in the article (particularly at areas where the defects are), in response to the application of the NDT material, and (optionally) another trigger—e.g., magnetization.

For example, with visual NDT inspections, the NDT material may be selected or configured to enable or enhance visual identification of defects, such as based on particular visual behavior—e.g., color contrast or some other light-related behavior. Various techniques or approaches may be used for the application of the NDT material to the inspect articles. One example approach is wet bench based setups. In this regard, in wet bench based setups the inspected articles are “bathed” using an NDT material—that is, the NDT material is applied to the inspected articles (e.g., using a hose-based system), before and/or during the inspection, to facilitate the detection of defects in the articles.

In some instances, the NDT inspections may entail use of a particular trigger for causing or enhancing detection of the defects, alone in combination with something else (e.g., NDT material applied to the inspected article). One example trigger that may be used during NDT inspections is magnetization, specifically when inspecting articles composed of or comprising ferrous material. In this regard, defects in such articles may be detected (e.g., visually) based on particular exhibited behavior or characteristics in response to magnetization to the articles, with the exhibited behavior or characteristics being rendered more detectable in some instances by application of NDT material to the articles. The magnetization may be achieved, for example, by application of electrical current through the article, magnetic induction (e.g., using handheld magnetization equipment), etc.

For example, as shown in FIG. 1, the NDT setup 100 may be a wet bench based setup configured for magnetic particle based inspections. In this regard, as shown in the example implementation illustrated in FIG. 1, the NDT setup 100 may include a wet bench 120, comprising a tank 122 that stores an NDT solution 124, which may be applied onto inspected articles (e.g., the article 102 as shown in FIG. 1), via a pump 126 and a hose 128. The NDT setup 100 of FIG. 1 also includes a current generator 110 that applies electrical current(s) to a to-be inspected article (e.g., part) 102 via electrical contacts 112. In this regard, various magnetization approaches may be used, with some systems allowing for selecting among such options.

The magnetization may be achieved using, for example, AC (alternating current), half wave DC (direct current), or full wave DC (direct current). In some systems, a demagnetization function may be built into the system. For example, the demagnetization function may utilize a coil and decaying AC (alternating current).

During inspection, the NDT material 124 (e.g., a wet magnetic particle solution) is applied to the part. The particle solution 124 (also called “bath”) may comprise visible or fluorescent particles that may be magnetized. The particle solution 124 may be collected and held in the tank 122. The pump 126 pumps the bath through a hose 128 to apply the particle solution 124 to the part 102 being inspected (e.g., via a nozzle 130 that is used in spraying the parts) and/or to collect samples of the particle solution 124 (e.g., in a container (not shown) for contamination analysis).

The NDT setup 100 may also incorporate a controller unit 140, configured for providing control related functions in the NDT setup 100, such as to control other components, to allow users to control the NDT setup 100 and/or inspections performed therein, etc. In this regard, the controller unit 140 may comprise suitable circuitry and input/output components (e.g., screen(s), speaker(s), keypad, etc.).

For example, the controller unit 140 may comprise suitable circuitry for generating control data applied to components of the NDT setup 100, for processing data generated during the NDT inspections (e.g., status data form components, data relating to inspected articles, etc.), for performing and/or controlling actions taken during NDT inspections, and the like. The disclosure is not so limited, however, and as such other combinations or variations may be supported. For example, the “controller” (or a portion thereof) may comprise or correspond to circuitry already included in the setup (e.g., circuitry in any light sources), which may be configured to performed some at least some of the functions attributed to the controller unit 140.

The controller 140 may incorporate a screen or display 142, which may be used to display information relating to NDT inspections performed in accordance with the present discloser. The disclosure is not so limited, however, and in some instances, the screen 142 (including minimal required circuitry) and the controller unit 140 may be implemented as separate components.

In an example implementation, the controller unit 140 may be configured to operate as a human machine interface (HMI) based unit, providing and/or supporting HMI based interactions with the user—e.g., via the display 142 and/or any other available input/output (I/O) devices within the controller 140 and/or the NDT setup 100 as a whole.

The NDT setup 100 may be configured, in accordance with the present disclosure, for supporting prompted setup and inspection. For example, when being used to perform a particular NDT inspection on particular article, the NDT setup 100 (e.g., via the controller unit 140) may select based on one or both of the non-destructive testing (NDT) inspection and the article being inspected, corresponding inspection guide dataset. The inspection guide dataset may be configured adaptively—e.g., for different types of inspections, different articles (e.g., based on type, product to which the article belong, etc.), inspection conditions or environment, different operators, etc. Thus, each article and/or inspection may have corresponding unique inspection guide dataset associated therewith. The inspection guide dataset may be configured to allow generating (e.g., via processing via the controller unit 140) corresponding one or more output indications for assisting the operator during the non-destructive testing (NDT) inspection of the article. In this regard, the one or more output indications may be provided to the operator (e.g., visually via an output component, such as the display 142, audibly via an audible output device (not shown), etc.).

The output indications may comprise instructions and/or information relating to performing the non-destructive testing (NDT) inspection. In this regard, providing the output indication may comprise determining, for each of output indication, corresponding output related conditions and/or parameters. Thus, each output indication may be provided to the user in accordance with the corresponding output related conditions and/or parameters. For example, the controller unit 140 may determine for each more output indication corresponding output related conditions and/or parameters based on one or more of: a type of inspection, a type of article, one or more parameters associated with the article, and a stage of inspection (e.g., initial setup and preparation, conducting the inspection, and post-inspection assessment).

In some implementations, controller unit 140 may store (e.g., via suitable storage components thereof) preprogrammed dataset corresponding to one or more inspection guide datasets (or at least a portion thereof).

In some implementations, controller unit 140 may adaptively generate or modify at least a portion of inspection guide datasets. The controller unit 140 may be configured for adaptively generating or modifying the inspection guide datasets (or portions thereof) based on a learning algorithm, for example. In an example implementation, the learning algorithm may be configured based on pattern recognition. Accordingly, the controller unit 140 may be configured for generate pattern recognition based control dataset for generating or modifying the at least a portion of the inspection guide dataset.

In an example use scenario, when trying to utilize the NDT setup 100 to conduct a particular inspection on a particular article (article 102), the user may identify the particular inspection and particular article—e.g., by inputting suitable identification information for both via an input component (e.g., keyboard, touchscreen, etc.) of the controller unit 140. The controller unit 140 may then search for corresponding inspection guide dataset based on the particular inspection and/or the particular article. Once identify, the controller unit 140 may determine corresponding output indications. In this regard, the output indications may correspond to various stages of the inspection, such as while preparing for the inspection, conducting the inspection, and/or assessing outcome of the inspection.

Each of the output indication may also have corresponding conditions and/or parameters associating with providing that output indication—e.g., when and how to provide it to the user. For example, one or more output indications may relate to or be associated with preparing the NDT setup 100 and/or the article 102 itself. This may include, for example, providing instructions relating to how to load the article 102 (e.g., how to attach to the contacts 112), how to set or configure the wet bench 120 (including, e.g., preparing the solution, performing any required agitation, etc.). One or more other output indications may pertain to conducting the inspection. For example, output indications may comprise visual output provided to the user via the display 142 to indicate how and when to apply the solution, when to stop, when to magnetize, etc. One or more other output indications may pertain to assessing the inspection. For example, output indications may comprise visual output provided to the user via the display 142 to assist the user in determining if any defects are present, if any such defects (or the article 102 as a whole) meeting any applicable acceptance criteria, etc.

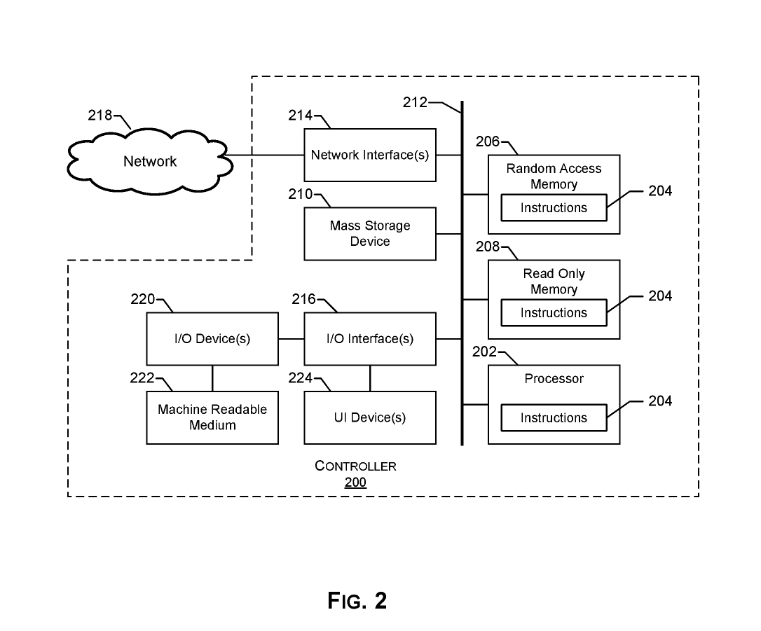

FIG. 2 illustrates an example controller for use in non-destructive testing (NDT) based setups supporting prompted setup and inspection, in accordance with aspects of the present disclosure. Shown in FIG. 2 is a controller system 200.

The controller system 200 may comprise suitable circuitry for implementing various aspects of the present disclosure, particularly for use in providing controller related functions in NDT setups implemented in accordance with the present disclosure. In this regard, the controller system 200 may represent an example implementation of the controller unit 140 of FIG. 1. Accordingly, the controller system 200 may be configured to support prompted setup and inspection, as described with respect to FIG. 1. For example, the controller system 200 may be configured for performing at least some of the functions associated with facilitating promoted setup and inspection, as described with respect to the NDT setup 100, and particularly the controller unit 140 thereof.

As shown in FIG. 2, the controller system 200 may include a processor 202. In this regard, the example processor 202 may be any general purpose central processing unit (CPU) from any manufacturer. In some example implementations, however, the processor 202 may include one or more specialized processing units, such as RISC processors with an ARM core, graphic processing units, digital signal processors, and/or system-on-chips (SoC).

The processor 202 executes machine readable instructions 204 that may be stored locally at the processor (e.g., in an included cache or SoC), in a random access memory (RAM) 206 (or other volatile memory), in a read only memory (ROM) 208 (or other non-volatile memory such as FLASH memory), and/or in a mass storage device 210. The example mass storage device 210 may be a hard drive, a solid state storage drive, a hybrid drive, a RAID array, and/or any other mass data storage device.

A bus 212 enables communications between the processor 202, the RAM 206, the ROM 208, the mass storage device 210, a network interface 214, and/or an input/output (I/O) interface 216.

The example network interface 214 includes hardware, firmware, and/or software to connect the controller system 200 to a communications network 218 such as the Internet. For example, the network interface 214 may include IEEE 202.X-compliant wireless and/or wired communications hardware for transmitting and/or receiving communications.

The example I/O interface 216 of FIG. 2 includes hardware, firmware, and/or software to connect one or more user interface devices 220 to the processor 202 for providing input to the processor 202 and/or providing output from the processor 202. For example, the I/O interface 216 may include a graphics processing unit for interfacing with a display device, a universal serial bus port for interfacing with one or more USB-compliant devices, a FireWire, a field bus, and/or any other type of interface.

The example controller system 200 includes a user interface device 224 coupled to the I/O interface 216. The user interface device 224 may include one or more of a keyboard, a keypad, a physical button, a mouse, a trackball, a pointing device, a microphone, an audio speaker, an optical media drive, a multi-touch touch screen, a gesture recognition interface, and/or any other type or combination of types of input and/or output device(s). While the examples herein refer to a user interface device 224, these examples may include any number of input and/or output devices as a single user interface device 224. Other example I/O device(s) 220 an optical media drive, a magnetic media drive, peripheral devices (e.g., scanners, printers, etc.), and/or any other type of input and/or output device.

The example controller system 200 may access a non-transitory machine readable medium 222 via the I/O interface 216 and/or the I/O device(s) 220. Examples of the machine readable medium 222 of FIG. 2 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine readable media.

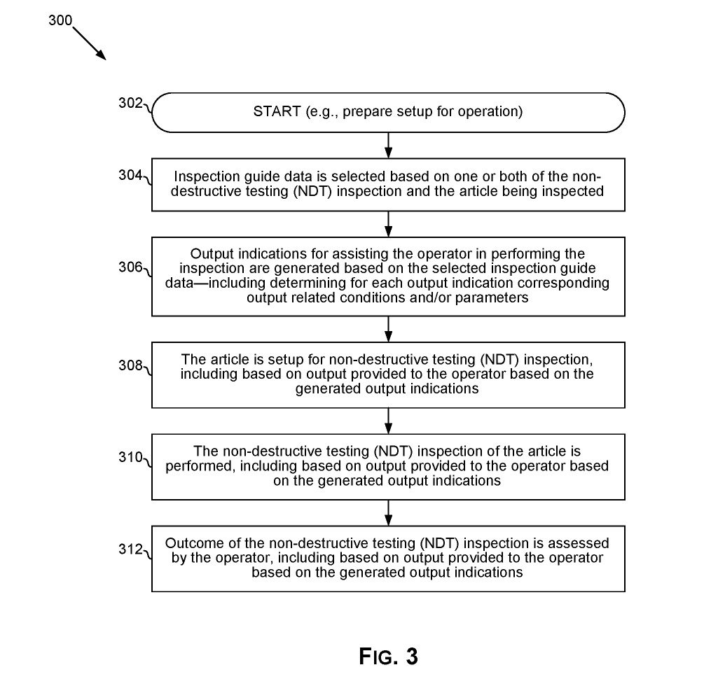

FIG. 3 illustrates a flowchart of an example process for conducting non-destructive testing (NDT) in an NDT inspection setup that supports prompted setup and inspection, in accordance with aspects of the present disclosure. Shown in FIG. 3 is flow chart 300, comprising a plurality of example steps (represented as blocks 302-312), which may be performed in a suitable system (e.g., NDT setup 100 of FIG. 1) when conducting a non-destructive testing (NDT) inspection in accordance with the present disclosure.

In start step 302, the NDT inspection setup is prepared for inspection (e.g., powering on components thereof, setting up the enclosure area, etc.).

In step 304, inspection guide data maybe selected based on one or both of the non-destructive testing (NDT) inspection and the article being inspected. In this regard, the inspection guide data or at least a portion thereof may be preprogrammed. Alternatively, in some instances, at least a portion of the inspection guide data may be adaptively generated or modified in the system, such as based on a learning algorithm.

In step 306, output indications for assisting the operator conducting the inspection are generated based on the selected inspection guide data. The output indications may comprise instructions and/or information relating or pertinent to performing the non-destructive testing (NDT) inspection. Generating the output indications may comprise determining each output indication corresponding output related conditions and/or parameters. For example, the output indications may be configured for generating visual and/or audible output, and the corresponding output related conditions and/or parameters may comprising specifying timing or other triggering conditions for displaying the output, manner or details relating to the output (e.g., displayed parameters, form of alert, etc.).

In step 308, the article is setup for non-destructive testing (NDT) inspection, including based on output provided to the operator based on the generated output indications. Setting up the article may include one or more of such actions as loading the article within the NDT setups (e.g., attaching it to holder component(s)), positioning the article in particular manner suitable for the inspection, applying NDT material to it before start of the inspection, etc. The output may pertain (e.g., provide details on how to perform) any of such actions.

In step 310, the non-destructive testing (NDT) inspection of the article may be conducted, including based on output provided to the operator based on the generated output indications. The output may pertain (e.g., provide details on how to perform) any of various steps that may be performed in the course of conducting the inspection, including any related actions pertinent to the inspection (e.g., magnetization, application of NDT material during the inspection, etc.). The output may include, for example, any setting and/or adjustments applicable during to the inspection (e.g., voltage settings), timing related output (when to perform certain steps), etc.

In step 312, outcome of the non-destructive testing (NDT) inspection of the article may be assessed, including based on output provided to the operator based on the generated output indications. The output may include, for example, details or pertinent information relating to determining if any defects are detected, whether any defects (or the article as a whole) meets acceptance (or rejection) criteria, and the like.

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made and equivalents may be substituted without departing from the scope of the present disclosure. For example, block and/or components of disclosed examples may be combined, divided, re-arranged, and/or otherwise modified. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

What is claimed is:

1. A system for use in non-destructive testing (NDT), the system comprising:
one or more inspection components configured to apply non-destructive testing (NDT) inspection of an article;
an output component configured to provide output to an operator of the system during the non-destructive testing (NDT) inspection; and
one or more circuits configured to:
select based on one or both of the non-destructive testing (NDT) inspection and the article, corresponding inspection guide data;
generate based on the selected inspection guide data, one or more output indications for assisting the operator during the non-destructive testing (NDT) inspection, wherein the one or more output indications comprise instructions and/or information relating to performing the non-destructive testing (NDT) inspection; and
provide the one or more output indications to the operator via the output component.

2. The system of claim 1, wherein the one or more circuits are configured to:
determine for each of the one or more output indications corresponding output related conditions and/or parameters; and
provide each of the one or more output indications via the output component to the operator based on the corresponding output related conditions and/or parameters.

3. The system of claim 2, wherein the one or more circuits are configured to determine for each of the one or more output indications corresponding output related conditions and/or parameters based on one or more of: a type of inspection, a type of article, one or more parameters associated with the article, and a stage of inspection.

4. The system of claim 1, wherein the one or more circuits are configured to store at least a preprogrammed portion of the inspection guide data.

5. The system of claim 1, wherein the one or more circuits are configured to adaptively generate or modify at least a portion of the inspection guide data.

6. The system of claim 5, wherein the one or more circuits are configured to adaptively generate or modify the at least a portion of the inspection guide data based on a learning algorithm.

7. The system of claim 6, wherein the learning algorithm is configured based on pattern recognition; and
wherein the one or more circuits are configured to generate pattern recognition based control data for generating or modifying the at least a portion of the inspection guide data.

8. The system of claim 1, wherein the output component comprises a visual output device.

9. The system of claim 1, wherein the output component comprises an audible output device.

10. The system of claim 1, wherein the system is configured for magnetic non-destructive testing (NDT) inspection.

11. The system of claim 10, wherein the one or more inspection components comprise, when the system is configured for magnetic non-destructive testing (NDT) inspection:
a current generator that generates an electrical current; and
one or more electrical contacts configured to apply the electrical current to the article during the magnetic non-destructive testing (NDT) inspection, wherein the application of the electric current creates a magnetic field in the inspection article.

12. The system of claim 10, wherein the system is configured as a magnetic wet bench, and wherein the one or more inspection components comprise:
a container configured for storing non-destructive testing (NDT) magnetic solution; and
an application system configured for applying the NDT magnetic solution during inspection.

13. The system of claim 12, wherein the one or more circuits are configured to:
power on the magnetic wet bench at a pre-set start time; and
cause agitating of the NDT magnetic solution for a pre-set agitation duration.

14. A method for non-destructive testing (NDT), the method comprising:
in response to one or more output indications provided to an operator via an output component of a non-destructive testing (NDT) setup, performing one or more actions corresponding to at least of:
setting up an article for non-destructive testing (NDT) inspection in the non-destructive testing (NDT) setup;
setting up and/or configuring at least one component of the non-destructive testing (NDT) setup;
conducting the non-destructive testing (NDT) inspection of the article; and
assessing outcome of the non-destructive testing (NDT) inspection of the article;
wherein:
the one or more output indications are configuring for assisting the operator during the non-destructive testing (NDT) inspection of the article;
the one or more output indications comprise instructions and/or information relating to performing the non-destructive testing (NDT) inspection;
the one or more output indications are generated based on a particular inspection guide data; and
the inspection guide data is selected based on one or both of the non-destructive testing (NDT) inspection and the article.

15. The method of claim 14, wherein setting up the article comprises at least one of:
loading the article within the non-destructive testing (NDT) setup;
securing the article in a particular position; and
applying to the article non-destructive testing (NDT) related material configured to exhibit one or more distinctive characteristics at areas in the article corresponding to defects.
